(19) United States
(12) Patent Application Publication
(10) Pub. No.: US 2020/0141484 A1
(43) Pub. Date: May 7, 2020

(54) HYDRAULIC CONTROL SYSTEM AND CONTROL METHOD THEREFOR

(71) Applicant: TOYOTA JIDOSHA KABUSHIKI KAISHA, Toyota-shi (JP)

(72) Inventors: Yoichi KODA, Toyota-shi (JP); Yasuyuki WATANABE, Toyota-shi (JP); Yuji NATSUGA, Miyoshi-shi (JP)

(73) Assignee: TOYOTA JIDOSHA KABUSHIKI KAISHA, Toyota-shi (JP)

(21) Appl. No.: 16/579,052

(22) Filed: Sep. 23, 2019

(30) Foreign Application Priority Data
Nov. 7, 2018 (JP) 2018-210070

(51) Int. Cl. F16H 61/14; F16H 61/02; F16H 61/00

(52) U.S. Cl. CPC F16H 61/143; F16H 61/0251; F16H 2061/026; F16H 61/0009; F16H 2061/145; F16H 61/0206

(57) ABSTRACT

A hydraulic control system includes an upper valve body, a lower valve body, a valve body plate provided between the upper valve body and the lower valve body and including a hole connecting a fluid passage of the upper valve body and a fluid passage of the lower valve body, a solenoid valve configured to control a pressure upstream of the hole of the valve body plate, and an electronic control unit. There is also a control method for the hydraulic control system. The electronic control unit is configured to, when the electronic control unit determines that a vehicle on which the hydraulic control system is mounted is stopped, decrease the pressure upstream of the hole of the valve body plate by controlling the solenoid valve.

### INCORPORATION BY REFERENCE

The disclosure of Japanese Patent Application No. 2018-210070 filed on Nov. 7, 2018 including the specification, drawings and abstract is incorporated herein by reference in its entirety.

### BACKGROUND

### 1. Technical Field

The disclosure relates to a hydraulic control system and a control method therefor.

### 2. Description of Related Art

Japanese Unexamined Patent Application Publication No. 2009-115267 (JP 2009-115267 A) describes a hydraulic control system including an upper valve body, a lower valve body, and a valve body plate. The valve body plate is provided between the upper valve body and the lower valve body, and includes holes that connect a fluid passage of the upper valve body and fluid passages of the lower valve body.

### SUMMARY

However, when the difference between the upstream-side pressure and downstream-side pressure of any of the holes provided in the valve body plate is large, the flow rate of hydraulic fluid passing through the hole increases, causing an increase in negative pressure. Thus, cavitation may occur inside the hole. When such cavitation occurs, high-frequency noise may occur.

The disclosure provides a hydraulic control system and a control method therefor, which are able to reduce occurrence of high-frequency noise.

A first aspect of the disclosure provides a hydraulic control system. The hydraulic control system includes an upper valve body, a lower valve body, a valve body plate provided between the upper valve body and the lower valve body, the valve body plate including a hole connecting a fluid passage of the upper valve body and a fluid passage of the lower valve body, a solenoid valve configured to control a pressure upstream of the hole, and an electronic control unit. The electronic control unit is configured to, when the electronic control unit determines that a vehicle on which the hydraulic control system is mounted is stopped, decrease the pressure upstream of the hole by controlling the solenoid valve.

With the hydraulic control system of the above aspect, hydraulic control for reducing occurrence of cavitation can be performed with the solenoid valve that is not affected in a stopped state of the vehicle.

In the above aspect, the hydraulic control system may include a plurality of the solenoid valves, the solenoid valves may be used to control an engaging pressure of an engagement element of a hydraulic frictional engagement device, and the solenoid valves may includes an engagement element on-off solenoid valve and a lockup on-off solenoid valve. The engagement element on-off solenoid valve may be configured to output a switching fluid pressure by using a modulator fluid pressure as a source pressure. The lockup on-off solenoid valve may be used to control an engaging pressure of a lockup clutch of a torque converter, and the lockup on-off solenoid valve may be configured to output a switching fluid pressure by using the modulator fluid pressure as a source pressure.

In the above aspect, the hydraulic frictional engagement device may be a forward-reverse switching device including a forward engagement element and a reverse engagement element, the forward engagement element may be provided in a path that transmits rotation in a direction to cause forward movement of the vehicle when the forward engagement element is engaged, the reverse engagement element may be provided in a path that transmits rotation in a direction to cause reverse movement of the vehicle when the reverse engagement element is engaged. The electronic control unit may be configured to, when the electronic control unit determines that the vehicle is stopped, place the engagement element on-off solenoid valve and the lockup on-off solenoid valve in an off position.

With the above configuration, normally, both the engagement element on-off solenoid valve and the lockup on-off solenoid valve that can be placed in an on position in preparation for a start of movement after a stop of the vehicle are placed in the off position, so occurrence of cavitation in a vehicle stopped state is reduced.

A second aspect of the disclosure provides a control method for a hydraulic control system. The hydraulic control system includes an upper valve body, a lower valve body, a valve body plate provided between the upper valve body and the lower valve body, the valve body plate including a hole connecting a fluid passage of the upper valve body and a fluid passage of the lower valve body, and a solenoid valve configured to control a pressure upstream of the hole. The control method includes decreasing the pressure upstream of the hole by controlling the solenoid valve, when it is determined that a vehicle on which the hydraulic control system is mounted is stopped.

With the control method for a hydraulic control system according to the above aspect, hydraulic control for reducing occurrence of cavitation can be performed with the solenoid valve that is not affected in a stopped state of the vehicle.

The hydraulic control system and control method therefor according to the aspects of the disclosure are advantageous in that, when it is determined that the vehicle is stopped, the pressure upstream of the hole of the valve body plate is decreased with the solenoid valve, with the result that no cavitation occurs, and, in a situation that high-frequency noise can be remarkable, generation of high-frequency noise is reduced by reducing the difference between the upstream-side pressure and downstream-side pressure of the hole.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram that illustrates the schematic configuration of a power transmission path of a vehicle including a hydraulic control system according to an embodiment;

FIG. 2 is a block diagram that illustrates major components of a control system provided in the vehicle;

FIG. 3 is a hydraulic circuit diagram that shows major components related to hydraulic control on speed shift control over a continuously variable transmission and hydraulic control on engagement of a forward clutch or reverse brake resulting from operation of a shift lever, in a hydraulic control circuit of the hydraulic control system;

FIG. 4 is a cross-sectional view that shows a relevant portion of a valve body that is a component of the hydraulic control circuit according to the embodiment; and

FIG. 5 is a flowchart that shows an example of hydraulic control that an electronic control unit that is a component of the hydraulic control system executes.

### DETAILED DESCRIPTION OF EMBODIMENTS

Hereinafter, an embodiment of a hydraulic control system according to the disclosure will be described. The present embodiment does not limit the disclosure.

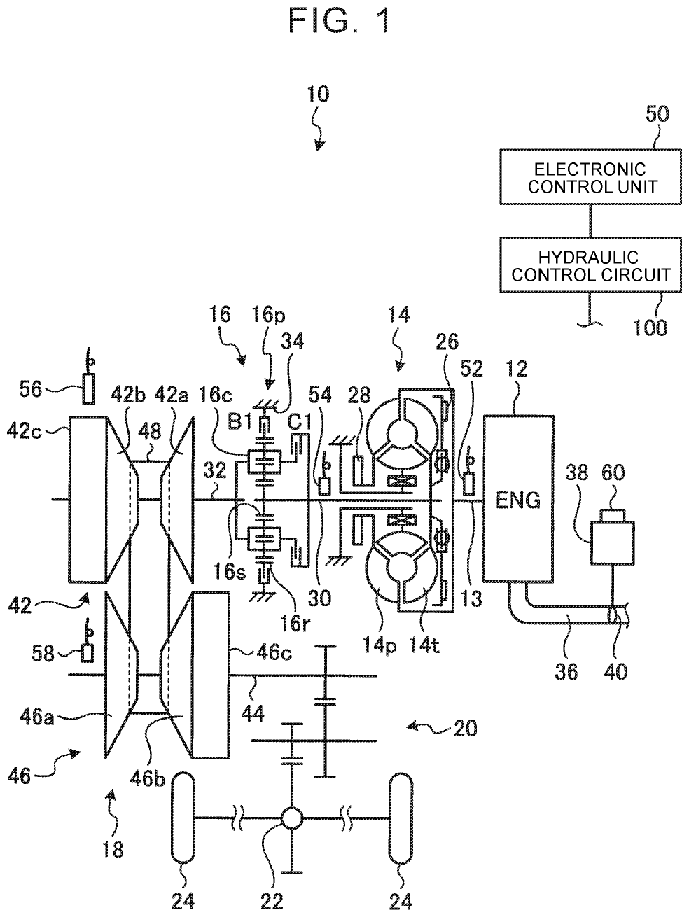

FIG. 1 is a diagram that illustrates the schematic configuration of a power transmission path of a vehicle 10 including a hydraulic control system according to the embodiment. In FIG. 1, for example, power generated by an engine 12 is transmitted to right and left drive wheels 24 sequentially via a torque converter 14, a forward-reverse switching device 16, a belt-type continuously variable transmission (CVT) 18, a reduction gear train 20, and a differential gear unit 22, and other parts. The engine 12 is used as a driving force source for propelling the vehicle. The torque converter 14 serves as a fluid transmission device. The CVT 18 serves as a continuously variable transmission for a vehicle.

The torque converter 14 includes a pump impeller 14p and a turbine runner 14t. The pump impeller 14p is coupled to a crankshaft 13 of the engine 12. The turbine runner 14t is coupled to the forward-reverse switching device 16 via a turbine shaft 30. The turbine shaft 30 may be regarded as an output-side member of the torque converter 14. The torque converter 14 transmits power via fluid. A lockup clutch 26 is provided between the pump impeller 14p and the turbine runner 14t. The lockup clutch 26 is engaged or disengaged when hydraulic pressures respectively supplied to an engaging-side fluid chamber and a disengaging-side fluid chamber are switched by a lockup control valve (that is, a lockup on-off solenoid valve) (not shown) in a hydraulic control circuit 100. When the lockup clutch 26 is completely engaged, the pump impeller 14p and the turbine runner 14t are integrally rotated. A mechanical oil pump 28 is coupled to the pump impeller 14p. The mechanical oil pump 28 generates hydraulic fluid pressure when driven by the engine 12 for rotation. The hydraulic fluid pressure is a fluid pressure for controlling a speed shift of the continuously variable transmission 18, generating a belt clamping force in the continuously variable transmission 18, controlling the torque capacity of the lockup clutch 26, switching the power transmission path in the forward-reverse switching device 16, or supplying lubricating oil to various portions of the power transmission path of the vehicle 10.

The forward-reverse switching device 16 is mainly made up of a forward clutch C1, a reverse brake B1, and a double-pinion planetary gear unit 16p. The turbine shaft 30 of the torque converter 14 is integrally coupled to a sun gear 16s. An input shaft 32 of the continuously variable transmission 18 is integrally coupled to a carrier 16c. The carrier 16c and the sun gear 16s are selectively coupled to each other via the forward clutch C1. A ring gear 16r is selectively fixed to a housing 34 via the reverse brake B1. The housing 34 serves as a non-rotating member. The forward clutch C1 and the reverse brake B1 each may be regarded as a connect-disconnect device. Each of the forward clutch C1 and the reverse brake B1 is a hydraulic frictional engagement device that is frictionally engaged by a hydraulic cylinder.

In the thus configured forward-reverse switching device 16, when the forward clutch C1 is engaged and the reverse brake B1 is disengaged, the forward-reverse switching device 16 is placed in an integrally rotatable state. As a result, the turbine shaft 30 is directly coupled to the input shaft 32, a forward power transmission path is established (achieved). Thus, driving force in a direction to cause forward movement is transmitted to the continuously variable transmission 18 side. When the reverse brake B1 is engaged and the forward clutch C1 is disengaged, a reverse power transmission path is established (achieved) in the forward-reverse switching device 16. As a result, the input shaft 32 is rotated in a reverse direction to the rotation direction of the turbine shaft 30. Thus, driving force in a direction to cause reverse movement is transmitted to the continuously variable transmission 18 side. When both the forward clutch C1 and the reverse brake B1 are disengaged, the forward-reverse switching device 16 is placed in a neutral state (transmission interrupted state) where transmission of power is interrupted.

The engine 12 is, for example, an internal combustion engine, such as a gasoline engine and a diesel engine. An electronic throttle valve 40 is provided in an intake pipe 36 of the engine 12. The electronic throttle valve 40 is used to electrically control the intake air volume Q_{AIR} of the engine 12 by using a throttle actuator 38.

The continuously variable transmission 18 includes a primary pulley 42, a secondary pulley 46, and a transmission belt 48. Power is transmitted via frictional force between the transmission belt 48 and each of the primary pulley 42 and the secondary pulley 46. The primary pulley 42 is an input-side member provided on the input shaft 32, and has a variable effective diameter. The secondary pulley 46 is an output-side member provided on an output shaft 44, and has a variable effective diameter. The transmission belt 48 is wound around the primary pulley 42 and the secondary pulley 46.

The primary pulley 42 includes a fixed sheave 42a, a movable sheave 42b, and a primary hydraulic cylinder 42c. The fixed sheave 42a serves as an input-side fixed rotating body fixed to the input shaft 32. The movable sheave 42b serves as an input-side movable rotating body provided so as to be relatively non-rotatable about an axis and movable in a direction of the axis with respect to the input shaft 32. The primary hydraulic cylinder 42c serves as a hydraulic actuator that applies primary thrust Wᵢₙ (=Primary pressure Pᵢₙ×Pressure receiving area of the movable sheave 42b) in the primary pulley 42 for changing the V-groove width between the fixed sheave 42a and the movable sheave 42b. The secondary pulley 46 includes a fixed rotating body (fixed sheave) 46a, a movable sheave 46b, and a secondary hydraulic cylinder 46c. The fixed sheave 46a serves as an output-side fixed rotating body fixed to the output shaft 44. The movable sheave 46b serves as an output-side movable rotating body provided so as to be relatively non-rotatable about an axis and movable in a direction of the axis with respect to the output shaft 44. The secondary hydraulic cylinder 46c serves as a hydraulic actuator that applies secondary thrust Wₒᵤₜ (=Secondary pressure Pₒᵤₜ×Pressure receiving area of the movable sheave 46b) in the secondary pulley 46 for changing the V-groove width between the fixed sheave 46a and the movable sheave 46b.

The input-side pressure that is applied to the primary pulley 42, that is, the primary pressure Pᵢₙ that is a fluid pressure that is applied to a fluid chamber in the primary hydraulic cylinder 42c, and the output-side pressure that is applied to the secondary pulley 46, that is, the secondary pressure Pₒᵤₜ that is a fluid pressure that is applied to a fluid chamber in the secondary hydraulic cylinder 46c, each are independently regulated and controlled by the hydraulic control circuit 100. Thus, each of the primary thrust Wᵢₙ and the secondary thrust Wₒᵤₜ is directly or indirectly controlled. As a result, the V-groove width of the primary pulley 42 and the V-groove width of the secondary pulley 46 vary, and the winding diameters (effective diameters) of the transmission belt 48 are changed. At the same time, a speed ratio γ (=Input shaft rotation speed N_{IN}/Output shaft rotation speed N_{OUT}) is continuously varied, and frictional force (belt clamping force) between the transmission belt 48 and each of the primary pulley 42 and the secondary pulley 46 is controlled such that the transmission belt 48 does not slip. In this way, since each of the primary pressure Pᵢₙ and the secondary pressure Pₒᵤₜ is controlled, an actual speed ratio γ is brought to a target speed ratio γ* while a slip of the transmission belt 48 is minimized. The input shaft rotation speed N_{IN} is the rotation speed of the input shaft 32. The output shaft rotation speed N_{OUT} is the rotation speed of the output shaft 44. In the present embodiment, as is apparent from FIG. 1, the input shaft rotation speed N_{IN} is the same as the rotation speed of the primary pulley 42, and the output shaft rotation speed N_{OUT} is the same as the rotation speed of the secondary pulley 46.

In the continuously variable transmission 18, for example, when the primary pressure Pᵢₙ is increased, the V-groove width of the primary pulley 42 is narrowed and the speed ratio γ is reduced, that is, the continuously variable transmission 18 shifts up. When the primary pressure Pᵢₙ is decreased, the V-groove width of the primary pulley 42 is widened and the speed ratio γ is increased, that is, the continuously variable transmission 18 shifts down. Therefore, when the V-groove width of the primary pulley 42 is a minimum, a minimum speed ratio γₘᵢₙ (maximum speed-side speed ratio, highest speed ratio) is established as the speed ratio γ of the continuously variable transmission 18. When the V-groove width of the primary pulley 42 is a maximum, a maximum speed ratio γₘₐₓ (minimum speed-side speed ratio, lowest speed ratio) is established as the speed ratio γ of the continuously variable transmission 18. While a slip of the transmission belt 48 (belt slip) is minimized by the primary pressure Pᵢₙ (which is synonymous with the primary thrust Wᵢₙ) and the secondary pressure Pₒᵤₜ (which is synonymous with the secondary thrust Wₒᵤₜ), a target speed ratio γ* is achieved based on the correlation between the primary thrust Wᵢₙ and the secondary thrust Wₒᵤₜ. An intended shift change is not achieved by only one of the pulley pressures (which are synonymous with the thrusts).

The hydraulic control system of the vehicle 10 according to the embodiment includes the hydraulic control circuit 100 and an electronic control unit 50. The hydraulic control circuit 100 supplies hydraulic pressure to targets to be supplied with fluid pressure in the vehicle 10. The electronic control unit 50 electrically controls the hydraulic control circuit 100 or other devices.

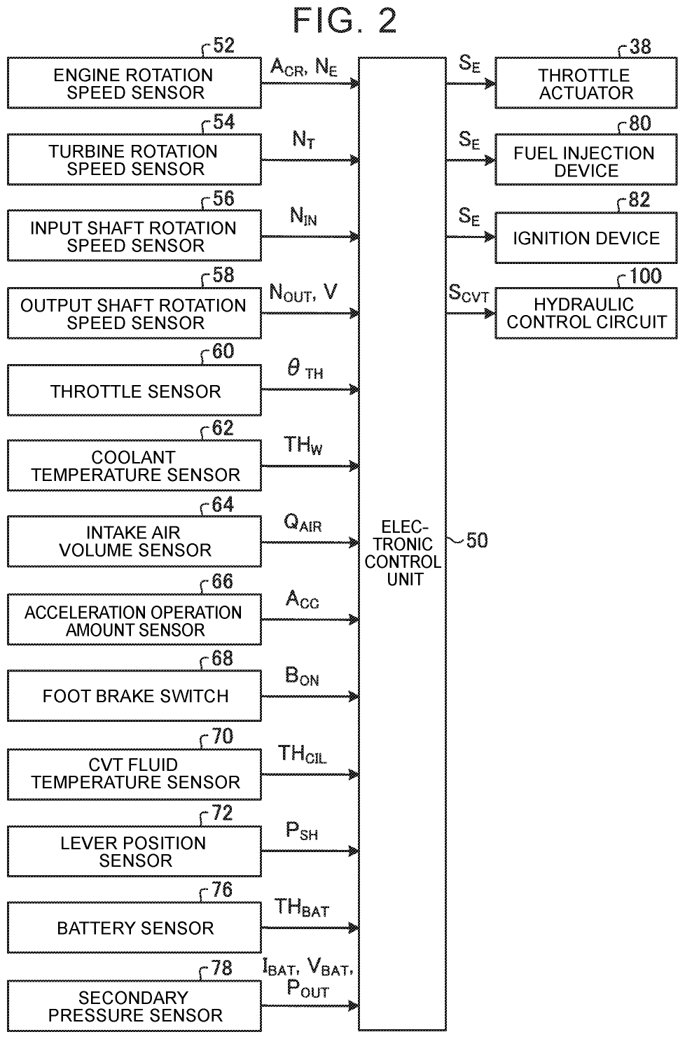

FIG. 2 is a block diagram that illustrates major components of a control system provided in the vehicle 10. In FIG. 2, the electronic control unit 50 includes a so-called microcomputer including, for example, a CPU, a RAM, a ROM, input and output interfaces, and other components. The CPU executes various control on the vehicle 10 by processing signals in accordance with programs stored in the ROM in advance while using the temporary storage function of the RAM. For example, the electronic control unit 50 is configured to execute output control on the engine 12, speed shift control and belt clamping force control on the continuously variable transmission 18, torque capacity control on the lockup clutch 26, and the like. The electronic control unit 50 is, where necessary, separately configured for engine control, hydraulic control for the continuously variable transmission 18 and the lockup clutch 26, and the like.

A signal indicating a rotation angle (position) A_{CR} of the crankshaft 13 and a rotation speed (engine rotation speed) N_{E} of the engine 12, a signal indicating a rotation speed (turbine rotation speed) N_{T} of the turbine shaft 30, a signal indicating an input shaft rotation speed N_{IN}, a signal indicating an output shaft rotation speed N_{OUT}, a signal indicating a throttle valve opening degree θ_{TH} of an electronic throttle valve 40, a signal indicating a coolant temperature TH_{W} of the engine 12, a signal indicating an intake air volume Q_{AIR} of the engine 12, a signal indicating an accelerator operation amount Acc, a signal indicating a brake on state B_{ON}, a signal indicating a fluid temperature TH_{OIL} of hydraulic fluid in the continuously variable transmission 18 or other devices, a signal indicating a lever position (operating position) P_{SH} of a shift lever 74, signals indicating a battery temperature TH_{BAT}, a battery charge-discharge current I_{BAT}, and a battery voltage V_{BAT}, a signal indicating a secondary pressure Pₒᵤₜ, and other signals, are supplied to the electronic control unit 50. The rotation angle (position) A_{CR} of the crankshaft 13 and the engine rotation speed N_{E} are detected by an engine rotation speed sensor 52. The turbine rotation speed N_{T} is detected by a turbine rotation speed sensor 54. The input shaft rotation speed N_{IN} is the input rotation speed of the continuously variable transmission 18 and is detected by an input shaft rotation speed sensor 56. The output shaft rotation speed N_{OUT} is the output rotation speed of the continuously variable transmission 18 and is detected by an output shaft rotation speed sensor 58. The output shaft rotation speed N_{OUT} corresponds to a vehicle speed V. The throttle valve opening degree θ_{TH} of the electronic throttle valve 40 is detected by a throttle sensor 60. The coolant temperature TH_{W} of the engine 12 is detected by a coolant temperature sensor 62. The intake air volume Q_{AIR} of the engine 12 is detected by an intake air volume sensor 64. The accelerator operation amount Acc that is the amount of operation of an accelerator pedal and that is an acceleration request amount of a driver is detected by an accelerator operation amount sensor 66. The brake on state B_{ON} indicates that an operating state of a foot brake that is a service brake is detected by a foot brake switch 68. The fluid temperature TH_{OIL} of hydraulic fluid in the continuously variable transmission 18 or other devices is detected by a CVT fluid temperature sensor 70. The lever position P_{SH} of the shift lever 74 is detected by a lever position sensor 72. The battery temperature TH_{BAT}, the battery charge-discharge current I_{BAT}, and the battery voltage V_{BAT} are detected by a battery sensor 76. The secondary pressure Pₒᵤₜ that is a fluid pressure supplied to the secondary pulley 46 is detected by a secondary pressure sensor 78. The electronic control unit 50, for example, calculates a state of charge (level of charge) (SOC) of a battery (electrical storage device) one after another based on the battery temperature TH_{BAT}, the battery charge-discharge current I_{BAT}, the battery voltage V_{BAT}, and the like. The electronic control unit 50, for example, calculates an actual speed ratio γ(=N_{IN}/N_{OUT}) of the continuously variable transmission 18 based on the output shaft rotation speed N_{OUT} and the input shaft rotation speed N_{IN}.

Engine output control instruction signals S_{E}, hydraulic control instruction signals S_{CVT}, and other instruction signals, are output from the electronic control unit 50. The engine output control instruction signals S_{E} are used for output control over the engine 12. The hydraulic control instruction signals S_{CVT} are used for hydraulic control related to a speed shift of the continuously variable transmission 18. Specifically, a throttle signal for controlling the open-close of the electronic throttle valve 40 by driving the throttle actuator 38, an injection signal for controlling the amount of fuel that is injected form a fuel injection device 80, an ignition timing signal for controlling the ignition timing of the engine 12 with an ignition device 82, and other signals are output as the engine output control instruction signals S_{E}. An instruction signal for driving a first linear solenoid valve SLP that regulates the primary pressure Pᵢₙ, an instruction signal for driving a second linear solenoid valve SLS that regulates the secondary pressure Pₒᵤₜ, an instruction signal for driving a third linear solenoid valve SLT (not shown) that controls a line fluid pressure P_{L}, and other signals are output to the hydraulic control circuit 100 as the hydraulic control instruction signals S_{CVT}.

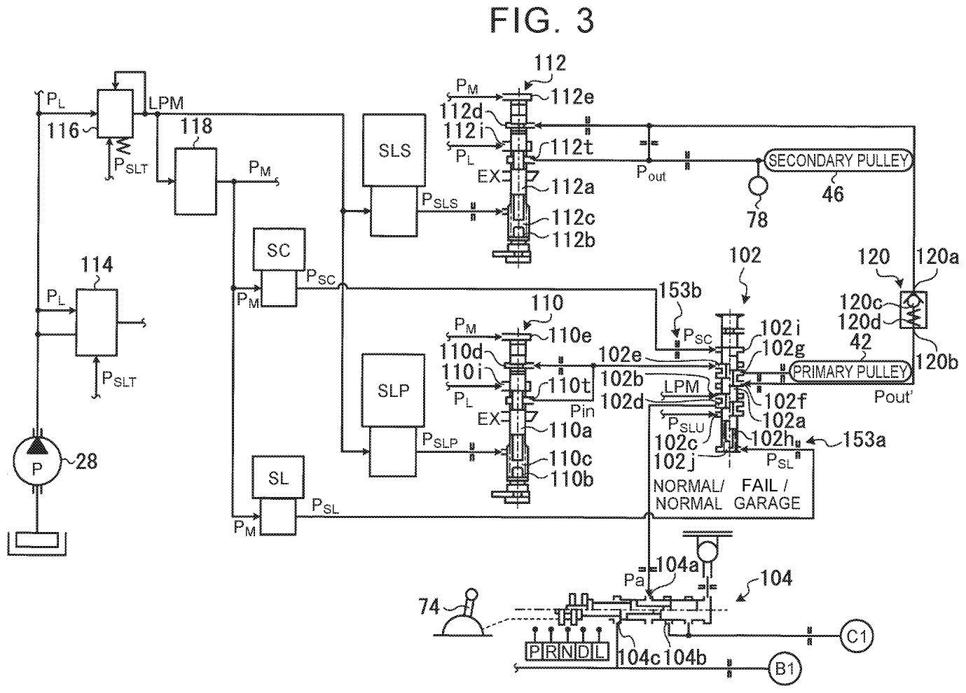

The shift lever 74 shown in FIG. 3 is, for example, disposed near a driver's seat. The shift lever 74 is manually operated to any one of five lever positions “P”, “R”, “N”, “D”, and “L” that are sequentially located. In “P” position (range), a neutral state is established. In the neutral state, the power transmission path of the vehicle 10 is opened, that is, transmission of power of the vehicle 10 is interrupted. The “P” position (range) is a parking position for stopping (locking) the rotation of the output shaft 44 mechanically with a mechanical parking mechanism. The “R” position is a reverse travel position for setting the rotation direction of the output shaft 44 in a reverse direction. The “N” position is a neutral position where the neutral state is established. The “D” position is a forward travel position where an automatic shift mode is established within a speed shift range in which a speed shift of the continuously variable transmission 18 is allowed and automatic shift control is executed. The “L” position is an engine brake position where strong engine brake is applied. In this way, the “P” position and the “N” position are non-travel positions that are selected when the power transmission path is placed in the neutral state and the vehicle is not caused to travel, and the “R” position, the “D” position, and the “L” position are travel positions that are selected when the power transmission path is placed in a power transmittable state where transmission of power is permitted and the vehicle is caused to travel.

FIG. 3 is a hydraulic circuit diagram that shows major components related to hydraulic control on speed shift control over the continuously variable transmission 18 and hydraulic control on engagement of the forward clutch C1 or reverse brake B1 resulting from operation of the shift lever 74, in the hydraulic control circuit 100.

In FIG. 3, the hydraulic control circuit 100 includes, for example, an oil pump 28, a clutch apply control valve 102, a manual valve 104, a primary pressure control valve 110, a secondary pressure control valve 112, a relief-type primary regulator valve 114, a line fluid pressure modulator valve 116, a modulator valve 118, a check valve 120, a first switching valve SC (that is, an engaging element on-off solenoid valve), a second switching valve SL (that is, an engaging element on-off solenoid valve), the first linear solenoid valve SLP, the second linear solenoid valve SLS, the third linear solenoid valve SLT (not shown), a fourth linear solenoid valve SLU (not shown), and the like. The clutch apply control valve 102 switches hydraulic fluid that is supplied to the forward clutch C1 and the reverse brake B1. The fluid passage of the manual valve 104 is mechanically changed in accordance with operation of the shift lever 74 such that the forward clutch C1 and the reverse brake B1 are selectively engaged or disengaged. The primary pressure control valve 110 regulates the primary pressure Pᵢₙ. The secondary pressure control valve 112 regulates the secondary pressure Pₒᵤₜ. The relief-type primary regulator valve 114 regulates the line fluid pressure P_{L} to a value according to an engine load, or the like, based on a control fluid pressure P_{SLT} by using hydraulic fluid pressure that is output (generated) from the oil pump 28 as a source pressure. The line fluid pressure modulator valve 116 outputs an output fluid pressure LPM of a constant pressure according to an engine load, or the like, based on the control fluid pressure P_{SLT} by using the line fluid pressure P_{L} as a source pressure. The modulator valve 118 outputs a modulator fluid pressure P_{M} regulated to a constant pressure by using the output fluid pressure LPM as a source pressure. The check valve 120 prevents application of the primary pressure Pᵢₙ to the secondary pulley 46-side fluid passage, and allows application of the secondary pressure Pₒᵤₜ to the primary pulley 42-side fluid passage. The first switching valve SC that is an on-off solenoid valve that outputs a switching fluid pressure P_{SC} by using the modulator fluid pressure P_{M} as a source pressure. The second switching valve SL that is an on-off solenoid valve that outputs a switching fluid pressure P_{SL} by using the modulator fluid pressure P_{M} as a source pressure. The first linear solenoid valve SLP, the second linear solenoid valve SLS, the third linear solenoid valve SLT (not shown), and the fourth linear solenoid valve SLU (not shown) respectively output a control fluid pressure P_{SLP}, a second control fluid pressure P_{SLS}, the control fluid pressure P_{SLT}, and a control fluid pressure P_{SLU} corresponding to driving currents that are supplied from the electronic control unit 50 by using the output fluid pressure LPM as a source pressure.

The clutch apply control valve 102 functions as a valve element that switches the status of supply of hydraulic fluid that is supplied to the forward clutch C1 and the reverse brake B1 via the manual valve 104 in accordance with the status of outputs of the first switching valve SC and second switching valve SL. The clutch apply control valve 102 includes a spool valve element 102a. The spool valve element 102a is movable in the direction of an axis. The spool valve element 102a is placed in any one of a normal position and a fail-garage position. In the normal position, hydraulic fluid that is supplied to the forward clutch C1 and the reverse brake B1 is the output fluid pressure LPM. In the fail-garage position, hydraulic fluid that is supplied to the forward clutch C1 and the reverse brake B1 is the control fluid pressure P_{SLU}. The clutch apply control valve 102 includes a first input port 102b, a second input port 102c, a first output port 102d, a third input port 102e, a fourth input port 102f, a second output port 102g, a spring 102h, a first fluid chamber 102i, and a second fluid chamber 102j. The output fluid pressure LPM is input to the first input port 102b. The control fluid pressure P_{SLU} is input to the second input port 102c. The first output port 102d is connected to an input port 104a of the manual valve 104, and communicates with any one of the first input port 102b and the second input port 102c depending on a switching position of the spool valve element 102a. The primary pressure Pᵢₙ is input to the third input port 102e. The secondary pressure Pₒᵤₜ is input to the fourth input port 102f via the check valve 120. The second output port 102g is connected to the primary pulley 42, and communicates with any one of the third input port 102e and the fourth input port 102f depending on a switching position of the spool valve element 102a. The spring 102h urges the spool valve element 102a toward the normal position. The first fluid chamber 102i receives the switching fluid pressure P_{SC} to apply thrust to the spool valve element 102a in a direction toward the fail-garage position. The second fluid chamber 102j receives the second switching fluid pressure P_{SL} to apply thrust to the spool valve element 102a in a direction toward the normal position.

In the thus configured clutch apply control valve 102, for example, when the switching fluid pressure P_{SC} of the first switching valve SC is supplied to the first fluid chamber 102i, the spool valve element 102a is moved toward the fail-garage position against the urging force of the spring 102h. At this time, the second input port 102c and the first output port 102d communicate with each other, and the control fluid pressure P_{SLU} of the fourth linear solenoid valve SLU is supplied to the input port 104a of the manual valve 104. That is, the control fluid pressure P_{SLU} of the fourth linear solenoid valve SLU becomes an engaging fluid pressure for the forward clutch C1 (or the reverse brake B1) Since the control fluid pressure P_{SLU} can be linearly varied based on the duty ratio of exciting current of the fourth linear solenoid valve SLU, an engagement transitional fluid pressure in process of engaging the forward clutch C1 (or the reverse brake B1) can be varied. For example, at the time of a garage shift (N-to-D shift or N-to-R shift) in which the shift lever 74 is operated from the “N” position to the “D” position or the “R” position when the vehicle is moving at a predetermined low vehicle speed, when the vehicle is stopped, or in other occasions, the control fluid pressure P_{SLU} is regulated in accordance with a predetermined rule such that the forward clutch C1 (or the reverse brake B1) is smoothly engaged and engagement shock is reduced. The fourth input port 102f and the second output port 102g communicate with each other, and the secondary pressure Pₒᵤₜ applied via the check valve 120 is supplied to the primary pulley 42.

On the other hand, when the first switching fluid pressure P_{SC} is not output from the first switching valve SC or when the second switching fluid pressure P_{SL} of the second switching valve SL is supplied to the second fluid chamber 102j, the spool valve element 102a is moved to the normal position side. At this time, the first input port 102b and the first output port 102d communicate with each other, and the output fluid pressure LPM is supplied to the input port 104a of the manual valve 104. That is, the output fluid pressure LPM becomes an engaging fluid pressure for the forward clutch C1 (or the reverse brake B1). Since the output fluid pressure LPM is a constant pressure regulated for an engine load, or the like (for example, input torque T_{IN}), an engaged state is stably held after engagement of the forward clutch C1 (or the reverse brake B1) is complete. For example, the forward clutch C1 (or the reverse brake B1) is placed in a completely engaged state during steady time, or the like, after the garage shift in which the forward clutch C1 (or the reverse brake B1) is engaged, the output fluid pressure LPM is at least regulated to a predetermined constant pressure and is regulated with the addition of a fluid pressure according to the control fluid pressure P_{SLT}. The third input port 102e and the second output port 102g communicate with each other, and the primary pressure Pᵢₙ is supplied to the primary pulley 42.

In the manual valve 104, an engaging fluid pressure Pₐ (control fluid pressure P_{SLU} or output fluid pressure LPM) output from the first output port 102d of the clutch apply control valve 102 is supplied to the input port 104a. When the shift lever 74 is operated to the “D” position or “L” position, the engaging fluid pressure Pₐ is supplied to the forward clutch C1 via a forward output port 104b, with the result that the forward clutch C1 is engaged. When the shift lever 74 is operated to the “R” position, the engaging fluid pressure Pₐ is supplied to the reverse brake B1 via a reverse output port 104c, with the result that the reverse brake B1 is engaged. When the shift lever 74 is operated to the “P” position or the “N” position, any of the fluid passages from the input port 104a to the forward output port 104b and the reverse output port 104c is interrupted and any of fluid passages for draining hydraulic fluid from the forward clutch C1 and the reverse brake B1 is communicated, with the result that both the forward clutch C1 and the reverse brake B1 are disengaged.

The primary pressure control valve 110 includes a spool valve element 110a, a spring 110b, a fluid chamber 110c, a feedback fluid chamber 110d, and a fluid chamber 110e. The spool valve element 110a is provided so as to be movable in the direction of an axis, and makes it possible to supply the line fluid pressure P_{L} from an input port 110i to the third input port 102e of the clutch apply control valve 102 via an output port 110t by opening or closing the input port 110i. The spring 110b serves as an urging device that urges the spool valve element 110a in a valve opening direction. The fluid chamber 110c accommodates the spring 110b, and receives the first control fluid pressure P_{SLP} to apply thrust to the spool valve element 110a in the valve opening direction. The feedback fluid chamber 110d receives the line fluid pressure P_{L} output from the output port 110t to apply thrust to the spool valve element 110a in a valve closing direction. The fluid chamber 110e receives the modulator fluid pressure P_{M} to apply thrust to the spool valve element 110a in the valve closing direction. The thus configured primary pressure control valve 110, for example, regulates the line fluid pressure P_{L} by using the first control fluid pressure P_{SLp} as a pilot pressure, and supplies the primary pressure Pᵢₙ to the fluid chamber in the primary hydraulic cylinder 42c via the clutch apply control valve 102. For example, as the first control fluid pressure P_{SL}p increases, the spool valve element 110a moves and, as a result, the primary pressure Pᵢₙ increases. On the other hand, as the first control fluid pressure P_{SLp} decreases, the spool valve element 110a moves and, as a result, the primary pressure Pᵢₙ decreases.

The secondary pressure control valve 112 includes a spool valve element 112a, a spring 112b, a fluid chamber 112c, a feedback fluid chamber 112d, and a fluid chamber 112e. The spool valve element 112a is provided so as to be movable in the direction of an axis, and makes it possible to supply the line fluid pressure P_{L} from an input port 112i to the secondary pulley 46 via an output port 112t as the secondary pressure Pₒᵤₜ by opening or closing the input port 112i. The spring 112b serves as an urging device that urges the spool valve element 112a in a valve opening direction. The fluid chamber 112c accommodates the spring 112b, and receives the second control fluid pressure P_{SLS} to apply thrust to the spool valve element 112a in the valve opening direction. The feedback fluid chamber 112d receives the secondary pressure Pₒᵤₜ output from the output port 112g to apply thrust to the spool valve element 112a in a valve closing direction. The fluid chamber 112e receives the modulator fluid pressure P_{M} to apply thrust to the spool valve element 112a in the valve closing direction. The thus configured secondary pressure control valve 112, for example, regulates the line fluid pressure P_{L} by using the second control fluid pressure P_{SLS} as a pilot pressure, and supplies the secondary pressure Pₒᵤₜ to the fluid chamber in the secondary hydraulic cylinder 46c. For example, as the second control fluid pressure P_{SLS} increases, the spool valve element 112a moves and, as a result, the secondary pressure Pₒᵤₜ increases. On the other hand, as the second control fluid pressure P_{SLS} decreases, the spool valve element 112a moves and, as a result, the secondary pressure Pₒᵤₜ decreases.

In the thus configured hydraulic control circuit 100, for example, the primary pressure Pᵢₙ that is regulated by the first linear solenoid valve SLP and the secondary pressure Pₒᵤₜ that is regulated by the second linear solenoid valve SLS are controlled such that belt clamping forces that minimize a belt slip and that are not unnecessarily high are generated in the primary pulley 42 and the secondary pulley 46. In the correlation between the primary pressure Pᵢₙ and the secondary pressure Pₒᵤₜ, the speed ratio γ of the continuously variable transmission 18 is changed by changing the thrust ratio τ(=Wₒᵤₜ/Wᵢₙ) between the primary pulley 42 and the secondary pulley 46 that are the pair of variable pulleys. For example, as the thrust ratio ti is increased, the speed ratio γ is increased (that is, the continuously variable transmission 18 shifts down).

The check valve 120 includes a poppet 120c and a spring 120d. The poppet 120c makes it possible to supply the secondary pressure Pₒᵤₜ to be supplied from an input port 120a to the fourth input port 102f of the clutch apply control valve 102 via an output port 120b as the primary pressure Pᵢₙ by opening or closing the input port 120a. The spring 120d serves as an urging device that urges the poppet 120c in a direction to close the input port 120a. In the thus configured check valve 120, when the secondary pressure Pₒᵤₜ is applied from the input port 120a and, as a result, a pressing force generated by the secondary pressure Pₒᵤₜ (=Pₒᵤₜ×Pressure receiving area S120 of the poppet 120c) exceeds an urging force F120 of the spring 120d, the input port 120a and the output port 120b communicate with each other, and the secondary pressure Pₒᵤₜ is supplied to the fourth input port 102f via the output port 120b. That is, when the secondary pressure Pₒᵤₜ exceeds a cracking pressure Pₖ, a secondary pressure Pₒᵤₜ′(=Pₒᵤₜ−Pₖ) that is a surplus pressure over the cracking pressure Pₖ is supplied to the fourth input port 102f as the primary pressure Pᵢₙ.

In this way, the check valve 120 regulates the primary pressure Pᵢₙ to a predetermined pressure according to the secondary pressure Pₒᵤₜ. Here, the check valve 120 regulates the primary pressure Pᵢₙ in the description. This regulation made by the check valve 120 here means that the primary pressure Pᵢₙ (secondary pressure Pₒᵤₜ′) is set to a predetermined pressure according to the secondary pressure Pₒᵤₜ based on check valve pressure regulation characteristics that depend on structural (mechanical) factors of the check valve 120 itself. That is, the regulation of pressure by the check valve 120 means that a pressure reduced to the primary pressure Pᵢₙ (secondary pressure Pₒᵤₜ′) set to a predetermined pressure according to the secondary pressure Pₒᵤₜ is output.

The hydraulic control circuit 100 according to the embodiment includes the clutch apply control valve 102, and is able to switch the fluid pressure that is supplied to the primary pulley 42 to any one of the primary pressure Pᵢₙ and the secondary pressure Pₒᵤₜ′ via the check valve 120. Therefore, in the event of failure (in the event of occurrence of failure) where the primary pressure Pᵢₙ is not normally output, fail-safe control is executed. Under the fail-safe control, the spool valve element 102a of the clutch apply control valve 102 is switched to the fail-garage position by outputting the first switching fluid pressure P_{SC}, and the secondary pressure Pₒᵤₜ″ supplied to the fourth input port 102f via the check valve 120 is supplied from the second output port 102g to the primary pulley 42. Examples of the event of failure assumes abnormal output of the first control fluid pressure P_{SLP}, and valve sticking of the primary pressure control valve 110. Particularly, in the event of failure that causes an unintended downshift, execution of such fail-safe operation is effective.

In this way, the clutch apply control valve 102 functions as a valve element that switches the engaging fluid pressure that is supplied to the forward clutch C1 (or the reverse brake B1) to the output fluid pressure LPM during steady time and that switches the engaging fluid pressure to the control fluid pressure P_{SLU} at the time of a garage shift. In addition, the clutch apply control valve 102 also functions as a valve element that switches the fluid pressure that is supplied to the primary pulley 42 to the primary pressure Pᵢₙ during normal times and that causes fail-safe operation to switch the fluid pressure into the secondary pressure Pₒᵤₜ′ via the check valve 120 in the event of failure.

Table 1 shows four hydraulic control modes that the hydraulic control system according to the embodiment is able to execute.

TABLE 1

| | | | | | | | TRAVEL |
|---|---|---|---|---|---|---|---|
| HYDRAULIC | SWITCHING | SWITCHING | PRIMARY | SECONDARY | FORWARD CLUTCH C1 | TORQUE | STATUS |
| CONTROL MODE | VALVE SC | VALVE SL | PULLEY | PULLEY | REVERSE BRAKE B1 | CONVERTER | (EXAMPLES) |
| (1) | OFF | OFF | CONTROL | CONTROL | Hi AT CONSTANT | LOCKUP | START |
| | | | WITH SLP | WITH SLS | PRESSURE | OFF | MOVING |
| (2) | OFF | ON | CONTROL | CONTROL | Lo AT CONSTANT | LOCKUP | TRAVEL WITH |
| | | | WITH SLP | WITH SLS | PRESSURE | ON | LOCKUP ON |
| (3) | ON | ON | CONTROL | CONTROL | Lo AT CONSTANT | LOCKUP | DECELERATE |
| | | | WITH SLP | WITH SLS | PRESSURE | OFF | BEFORE STOP |
| (4) | ON | OFF | CONTROL | CONTROL | CONTROL | LOCKUP | GARAGE SHIFT |
| | | | WITH SLS | WITH SLS | WITH SLU | OFF | CONTROL |
| | | | | | | | NEUTRAL |
| | | | | | | | CONTROL |
| | | | | | | | S&S CONTROL |
| | | | | | | | FAIL-SAFE |
| | | | | | | | CONTROL |

In hydraulic control mode (1), the first switching valve SC is in the OFF position, the second switching valve SL is in the OFF position, the primary pulley 42 is controlled with the first linear solenoid valve SLP, the secondary pulley 46 is controlled with the second linear solenoid valve SLS, the forward clutch C1 and the reverse brake B1 are placed in a Hi position at a constant pressure, and lockup of the torque converter 14 is in the OFF state. The hydraulic control mode (1) is used, for example, when the vehicle 10 starts moving, and allows the vehicle 10 to travel in a normal lockup OFF state.

In hydraulic control mode (2), the first switching valve SC is in the OFF position, the second switching valve SL is in the ON position, the primary pulley 42 is controlled with the first linear solenoid valve SLP, the secondary pulley 46 is controlled with the second linear solenoid valve SLS, the forward clutch C1 and the reverse brake B1 are placed in a Lo position at a constant pressure, and lockup of the torque converter 14 is in the ON state. A lockup differential pressure is controlled with the fourth linear solenoid valve SLU. The hydraulic control mode (2), for example, allows the vehicle 10 to travel in a normal lockup ON state. There is no torque amplification of the torque converter 14 and input torque reduces, so drag torque of a drum seal ring (not shown) of the forward clutch C1 is reduced by decreasing the pressure applied to the forward clutch C1. Thus, improvement of fuel consumption is achieved.

In hydraulic control mode (3), the first switching valve SC is in the ON position, the second switching valve SL is in the ON position, the primary pulley 42 is controlled with the first linear solenoid valve SLP, the secondary pulley 46 is controlled with the second linear solenoid valve SLS, the forward clutch C1 and the reverse brake B1 are placed in a Lo position at a constant pressure, and lockup of the torque converter 14 is placed in the OFF state. Although the second switching valve SL is in the ON position, lockup is placed in the OFF position when the first switching valve SC is set in the ON position. When both the first switching valve SC and the second switching valve SL are in the ON position, engine stall is prevented when lockup is placed in the OFF state. The hydraulic control mode (3) is used, for example, when the vehicle 10 decelerates before a stop. Although lockup is in the OFF state, the flow rate of fluid to pulley speed shift (belt return) is ensured by reducing the amount of fluid leakage in the solenoid through a decrease in the output fluid pressure LPM during deceleration, and improvement of fuel consumption is achieved.

In hydraulic control mode (4), the first switching valve SC is in the ON position, the second switching valve SL is in the OFF position, the primary pulley 42 is controlled with the second linear solenoid valve SLS, the secondary pulley 46 is controlled with the second linear solenoid valve SLS, the forward clutch C1 and the reverse brake B1 are controlled with the fourth linear solenoid valve SLU, and lockup of the torque converter 14 is placed in the OFF state. The hydraulic control mode (4) is used in, for example, garage shift control mode, fail-safe mode, neutral control, S&S control (described in the next paragraph), and other control.

The garage shift control mode is a mode in which the forward clutch C1 and the reverse brake B1 are controlled with the fourth linear solenoid valve SLU. The fail-safe mode is a mode in which the primary pressure Pᵢₙ is not controlled with the first linear solenoid valve SLP (fail-safe mode intended for failure of the first linear solenoid valve SLP). The neutral control (N control) is control to continue releasing a clutch that transmits the output torque of the engine 12 to the continuously variable transmission 18 while the engine 12 runs at idle (autonomously rotates). The S&S control is control to disconnect the engine 12 from the power transmission path by placing the lockup clutch 26 in the OFF state during deceleration in the brake ON state where the foot brake is depressed while the vehicle is traveling forward, and to stop the rotation of the engine 12 by stopping, for example, supply of fuel to the engine 12.

The first switching valve SC switches whether to keep a constant pressure or gradually increase the pressure in the fluid passage of the forward clutch C1. Therefore, when the first switching valve SC is set in the ON position in hydraulic control mode (4), a shock due to application of a sudden constant pressure is reduced at the time of garage shift operation.

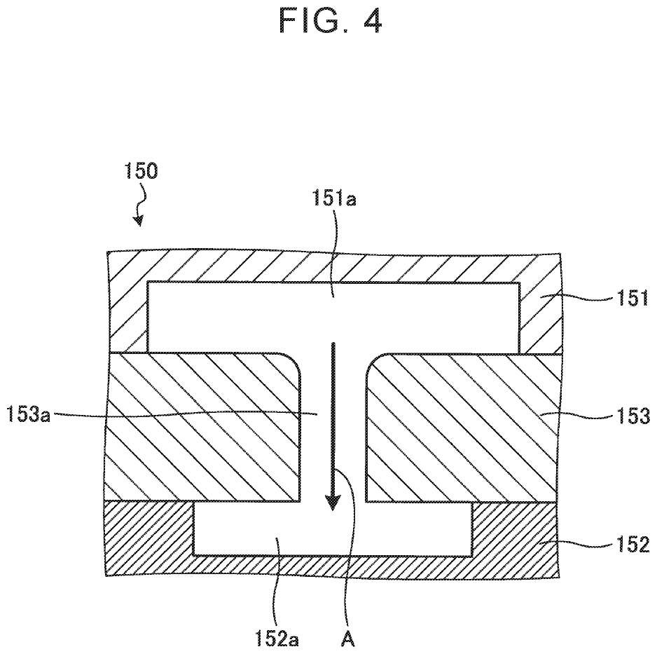

FIG. 4 is a cross-sectional view that shows a relevant portion of a valve body 150 that is a component of the hydraulic control circuit 100 according to the embodiment.

The valve body 150 that is a component of the hydraulic control circuit 100 according to the embodiment includes an upper valve body 151, a lower valve body 152, and a valve body plate 153. The valve body plate 153 is provided between the upper valve body 151 and the lower valve body 152. In the valve body 150, the lower valve body 152, the valve body plate 153, and the upper valve body 151 are stacked in this order. The valve body plate 153 includes an orifice 153a that is a hole extending through in the thickness direction of the upper valve body 151. The orifice 153a connects a fluid passage 151a of the upper valve body 151 and a fluid passage 152a of the lower valve body 152. The orifice 153a has the function of reducing fluid pressure.

The upper valve body 151 and the lower valve body 152 each have a plurality of fluid passages other than the fluid passage 151a or fluid passage 152a shown in FIG. 4. The valve body plate 153 also includes a plurality of orifices for connecting the plurality of fluid passages between the upper valve body 151 and the lower valve body 152, other than the orifice 153a shown in FIG. 4.

FIG. 4 shows part of a fluid passage that leads from the second switching valve SL to the clutch apply control valve 102 as an example. That is, the fluid passage 151a of the upper valve body 151 communicates with the second switching valve SL, and the fluid passage 152a of the lower valve body 152 communicates with the clutch apply control valve 102. Fluid flowing from the second switching valve SL through the fluid passage 151a of the upper valve body 151 passes through the orifice 153a of the valve body plate 153, flows through the fluid passage 152a of the lower valve body 152, and is then supplied to the clutch apply control valve 102. As another example, even in the middle of the fluid passage that leads from the first switching valve SC to the clutch apply control valve 102, a similar configuration to that shown in FIG. 4 is provided.

In the valve body 150 shown in FIG. 4, when hydraulic fluid flows from the fluid passage 151a of the upper valve body 151 through the orifice 153a in the direction of the arrow A in FIG. 4, a negative pressure is generated inside the orifice 153a when the flow rate is high. A negative pressure generated inside the orifice 153a causes cavitation, with the result that high-frequency noise occurs. Generally, the flow rate and negative pressure of hydraulic fluid flowing through an orifice are affected by the difference between the pressures of both sides of the orifice (the difference between the upstream-side pressure and downstream-side pressure of the orifice) and the shape of the orifice.

The inventors of the subject application diligently made a study over and over, and finally found that the difference between the pressures of both sides of the orifice significantly contributed to the flow rate and negative pressure of hydraulic fluid flowing through the orifice. For this reason, in the hydraulic control system according to the embodiment, for example, since an upstream pressure that is a fluid pressure on the upstream side of the orifice 153a in the direction of flow of hydraulic fluid is controlled with the second switching valve SL, the difference between the pressures of both sides of the orifice 153a is reduced by decreasing the pressure upstream of the orifice 153a with the second switching valve SL. Thus, generation of the radio-frequency noise is reduced. Similarly, since an upstream pressure that is a fluid pressure on the upstream side of an orifice 153b (see FIG. 3) in the direction of flow of hydraulic fluid is controlled with the first switching valve SC, the differential pressure between both sides of the orifice 153b is reduced by decreasing the upstream pressure upstream of the orifice 153b with the first switching valve SC. Thus, generation of the high-frequency noise is reduced.

In the hydraulic control system according to the embodiment, when the electronic control unit 50 determines that the vehicle 10 is stopped, the electronic control unit 50 executes hydraulic control such that the pressures upstream of the orifices 153a, 153b of the valve body plate 153 are decreased with the first switching valve SC and the second switching valve SL.

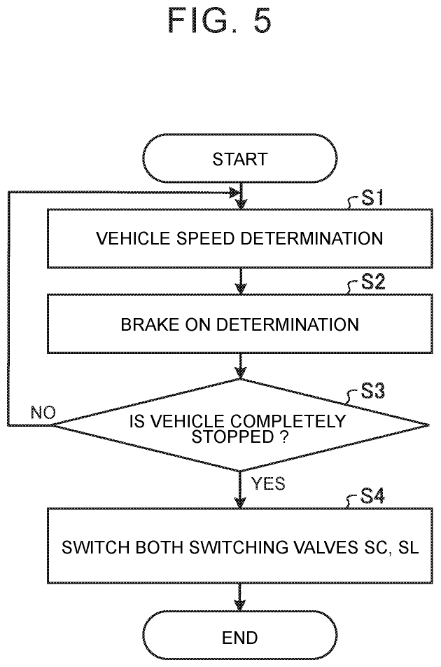

FIG. 5 is a flowchart that shows an example of hydraulic control that the electronic control unit 50 that is a component of the hydraulic control system executes. First, the electronic control unit 50 determines the vehicle speed of the vehicle 10 (step S1). In this determination of vehicle speed, the electronic control unit 50 determines whether the vehicle speed of the vehicle 10 is zero [km/h] based on the rotation speed N_{OUT} that is a signal from the output shaft rotation speed sensor 58. Subsequently, the electronic control unit 50 carries out brake ON determination (step S2). In this brake ON determination, the electronic control unit 50 determines whether the brake is in the ON state based on, for example, a signal from a stop lamp switch (not shown) provided in the vehicle 10. After that, the electronic control unit 50 carries out complete stop determination on the vehicle 10 (step S3). In this complete stop determination, the electronic control unit 50 determines that the vehicle 10 is in a completely stopped state when the vehicle speed is zero [km/s] and the brake is in the ON state based on the result of determination of step S1 and the result of determination of step S2. When the electronic control unit 50 determines that the vehicle 10 is not in the completely stopped state (No in step S3), the electronic control unit 50 returns to the process of step S1. On the other hand, when the electronic control unit 50 determines that the vehicle 10 is in the completely stopped state (Yes in step S3), the electronic control unit 50 switches the first switching valve SC and also switches the second switching valve SL. Here, it is assumed that, in preparation for the start of movement of the stopped vehicle 10, the electronic control unit 50 once executes the hydraulic control mode (1) shown in Table 1, and places both the first switching valve SC and the second switching valve SL in the OFF position. In switching of both the first switching valve SC and the second switching valve SL in step S3, the electronic control unit 50 switches both the first switching valve SC and the second switching valve SL from the OFF position to the ON position to decrease the pressures upstream of the orifices 153a, 153b. After switching of both the first switching valve SC and the second switching valve SL, the electronic control unit 50 ends a series of control.

As described above, with the hydraulic control system according to the embodiment, when it is determined that the vehicle 10 is stopped, the pressures upstream of the orifices of the valve body plate 153 are decreased by the solenoid valves such as the first switching valve SC and the second switching valve SL, so no cavitation (ground noise) occurs. In a situation that high-frequency noise can be remarkable, generation of high-frequency noise is reduced by reducing the difference between the pressures of both sides of each orifice (the difference between the upstream-side pressure and downstream-side pressure of each orifice).

What is claimed is:

1. A hydraulic control system comprising:
an upper valve body;
a lower valve body;
a valve body plate provided between the upper valve body and the lower valve body, the valve body plate including a hole connecting a fluid passage of the upper valve body and a fluid passage of the lower valve body;
a solenoid valve configured to control a pressure upstream of the hole; and
an electronic control unit configured to, when the electronic control unit determines that a vehicle on which the hydraulic control system is mounted is stopped, decrease the pressure upstream of the hole by controlling the solenoid valve.

2. The hydraulic control system according to claim 1, wherein:
the hydraulic control system includes a plurality of the solenoid valves;
the solenoid valves are used to control an engaging pressure of an engagement element of a hydraulic frictional engagement device; and
the solenoid valves includes an engagement element on-off solenoid valve and a lockup on-off solenoid valve, the engagement element on-off solenoid valve being configured to output a switching fluid pressure by using a modulator fluid pressure as a source pressure, the lockup on-off solenoid valve being used to control an engaging pressure of a lockup clutch of a torque converter, and the lockup on-off solenoid valve being configured to output a switching fluid pressure by using the modulator fluid pressure as a source pressure.

3. The hydraulic control system according to claim 2, wherein:
the hydraulic frictional engagement device is a forward-reverse switching device including a forward engagement element and a reverse engagement element, the forward engagement element is provided in a path that transmits rotation in a direction to cause forward movement of the vehicle when the forward engagement element is engaged, the reverse engagement element is provided in a path that transmits rotation in a direction to cause reverse movement of the vehicle when the reverse engagement element is engaged; and
the electronic control unit is configured to, when the electronic control unit determines that the vehicle is stopped, place the engagement element on-off solenoid valve and the lockup on-off solenoid valve in an off position.

4. A control method for a hydraulic control system, the hydraulic control system including an upper valve body, a lower valve body, a valve body plate provided between the upper valve body and the lower valve body, the valve body plate including a hole connecting a fluid passage of the upper valve body and a fluid passage of the lower valve body, and a solenoid valve configured to control a pressure upstream of the hole, the control method comprising:
decreasing the pressure upstream of the hole by controlling the solenoid valve, when it is determined that a vehicle is stopped.
